(19) United States
(12) Patent Application Publication
(10) Pub. No.: US 2005/0140816 A1
(43) Pub. Date: Jun. 30, 2005

(54) System comprising a camera, passive accessory component and a control device therefor

(76) Inventors: Christian Tschida, Gablitz (AT); Martin Waitz, Wien (AT)

Correspondence Address: Lerner and Greenberg, P O Box 2480, Hollywood, FL, 33020-2480, US

(21) Appl. No.: 10/502,147

(22) PCT Filed: Jan. 14, 2003
(86) PCT No.: PCT/AT03/00011

(30) Foreign Application Priority Data
Jan. 18, 2002 (AT) A 87/2002

(51) Int. Cl. G03B 17/00

(52) U.S. Cl. 348/360

(57) ABSTRACT

A camera system comprising has at least one passive camera accessory component and a control device for the passive camera accessory component. A contactless memory medium is mounted on the passive accessory component and an electronic acquisition device is associated with the control device for communication with the contactless memory medium.

The invention relates to a system comprising a camera with at least one passive camera-accessory component and with a control device therefor.

Furthermore, the invention relates to a passive accessory component for a camera as well as, moreover, to a control device for at least one passive accessory component in association with a camera.

In modern movie technology, a large number of accessory components are used with cameras. The complete active and passive accessories which are connected with the camera so as to attain the desired images is called camera system. In this context, active accessories are understood to be electric and electronic components which carry out controlling, regulating or visualizing functions of the camera, and which have an interface for a data exchange. By this, accessory-specific data can be transmitted to the control device of a camera system. Such active accessories include, e.g.,
drive systems for lenses;
intelligent operating elements (equipped with the appropriate electronic means) of the camera;
displays for visualizing camera data and date of attached components;
data recording apparatus;
units for functions which can be automated;
electric film magazines; and
electric adjustment lens apertures.

Other components required for operating the camera and not corresponding to the above-indicated criteria of the active accessories are called passive accessories. They include mechanical, optical and electrical accessory components lacking the possibility to communicate with the control electronics of the camera system. These passive accessories include, e.g.,
lenses;
view finder systems;
mechanical film magazines;
image format windows;
mechanical adjustment lens apertures;
optical filter systems; and
batteries or other power supply components.

The term “camera system” is understood to be e.g. a movie camera or a video camera with its active and passive accessories. In many applications, the configuration of a camera is continuously changed during a shooting. When exchanging active components most of which include processors, it is state of the art to adapt the control device of the camera system to the new configurations and to store adjusted positions of the accessories. If passive accessory components are exchanged, this cannot be recognized by the control device. Accessory-specific adjusted positions possibly effected therefore will be lost during such an exchange.

In the movie industry, the camera systems mostly are owned by rentals, and when making a movie, the required equipment is rented by the producing companies and is operated mostly by free-lance cameramen and camera assistants. In the field of shooting technique, comprehensive electronic equipment (active accessories) and a plurality of passive accessory components are used for producing the most varying effects. In connection therewith, the configuration of the camera system often is changed several times a day. By the increasing number of the possible functionalities, the user interfaces of the camera systems become ever more complex. However, many users use only a small number of the many possible functionalities and visualizations.

When using the equipment, each user also gathers a great deal of information which he must know when using a product, yet does not want other users to know. Observations regarding the quality of a lens in different applications may be mentioned here by way of example. Thus, a cameraman may find during his work that a zoom lens having a focal distance of 28-60 mm according to his opinion has a poor quality at the focal distance of 40-45 mm.

Therefore, it would be desirable for the user of camera systems to have a technique available to
detect the exchange of passive accessories;
provide information on the actual accessory components to the control and display units of a camera system;
up-date the representation of displays after exchanging passive accessory components;
store information regarding a passive accessory used and reproduce it during a new use of this accessory;
simply store user-specific adaptations to the user interface and to reproduce them during a new use of the equipment;
reduce the user interface of a camera system to the functionalities required by the user so as to allow for a clear and simple handling; and
store product-specific data and to display the stored information in automated manner when using the product again.

Therefore, it is an object of the invention to provide a system, a passive accessory component and a control device of the initially defined type so as to comply with the previously indicated aims as completely as possible. In particular, information should not be lost during an exchange of passive accessory components, and also an individual storage of information is to be made feasible which will only be available to the respective operating person (cameraman etc.). Moreover, an adequate display of information regarding the respective passive accessory and its operation, particularly under a user-specific adaptation, is to be made feasible.

The system according to the invention and of the initially defined type is characterized in that a contactless memory medium is mounted on the passive accessory component and that the control device has an electronic acquisition device for communicating with the contactless memory medium. There, the contactless memory medium preferably is formed by a per se conventional transponder, and the electronic acquisition device is a per se known writing and reading device (even though also cases would be conceivable in which the acquisition device is a mere writing device or also a mere reading device—when using passive accessory components that have already been “marked”).

Likewise, the passive accessory component according to the invention is characterized by a contactless memory medium, in particular a transponder known per se, mounted thereon.

According to a further aspect of the invention, the inventive control device is characterized by the association of an electronic acquisition device for communicating with a contactless memory medium on the passive accessory component. According to another aspect, such a control unit is characterized by a memory unit comprising at least one mobile memory medium provided for storing data specific of the passive accessory component.

When using a passive accessory component in a camera system for the first time, data associated to this passive accessory component during the first operation thereof, such as especially data obtained in the course of calibrating a servo drive, can be stored—in the contactless memory medium on this accessory component—in associated relationship, and when this passive accessory component then is removed and used again later on, the data stored in the contactless memory medium will immediately be available again, and they can be recognized by the electronic acquisition device and used accordingly in the control device of the system. Besides being directly mounted on the accessory component itself, the memory medium may, of course, also be attached on the wrapping of the accessory, with the same function being attained, i.e., for instance in case of a lens, when mounting the latter, the data can be read out in the same manner from the memory medium attached to a lens cartridge.

In particular, the contactless memory medium is adapted for storing data specific of the passive accessory component and/or specific of its operation. When associating a servo or drive motor for the passive accessory component, e.g. a servomotor for a lens, preferably counting values of the drive motor from the contactless medium are stored in combination with associated scale or engraved values of the passive accessory component. Thereafter, a visualization of motor and lens information belonging together will also be possible at any time.

Of course, the invention is not only applicable with lenses, but with any desired other passive accessory components, such as have been listed in the beginning.

Furthermore, if a control device is provided which has an associated memory unit with a mobile memory medium, preferably a memory card, for storing data specific of the passive accessory component and/or of the operation thereof, the respective data can be stored as personal data on a personal, exchangeable memory medium, preferably a memory card, and can be saved by the person interested, e.g. a cameraman, in individual association. Optionally, the mobile memory medium allows for a storage of information beyond that information which can be stored on the contactless memory medium at the respective passive accessory component. It is, e.g., conceivable to store (additionally) information relating to the quality or special properties of specific passive accessory components for personal purposes so that when using the passive accessory component, these properties of the latter will immediately be pointed out. Moreover, it is also possible to draw on the data stored in the mobile “personal” memory medium instead of drawing on those which are stored in the transponder on the accessory component for recognizing the respective accessory component and for adjustment and operation thereof.

For displaying such information and also information read out from the contactless memory medium of the respective passive accessory component, the control device preferably is equipped with a display device, and the aforementioned specific information relating to the accessory components and their individual properties can be displayed on this display device; also the memory card can be adapted to store information regarding this display device, and its configuration, respectively, wherein especially information regarding the configuration of the display device can be stored in dependence on the passive accessory component concerned. The display device may, moreover, also display the actual positions of the servo-devices, or drive motors, respectively, associated with the respective passive accessory components.

Preferably, the camera may be a movie camera, yet it may also be formed by a video camera or by a photographic camera, e.g. Furthermore, also several passive accessory components may be provided in the system during an application thereof, e.g. when shooting a movie, in which case data relating to all the passive accessory components used will then be stored, or read out, or displayed, respectively.

In the following, the invention will be explained in more detail by way of preferred exemplary embodiments illustrated in the drawings to which, however, it shall not be restricted.

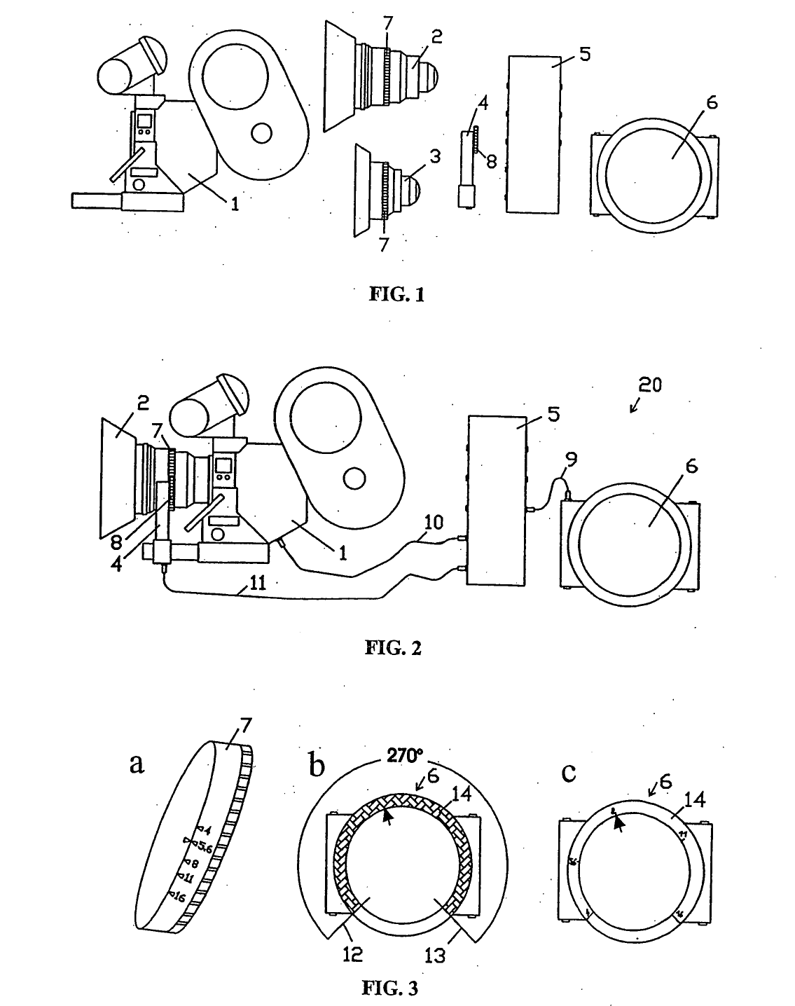

FIG. 1 schematically represents a simple example of a conventional camera system with relatively few accessory components showing them individually;

FIG. 2 shows this camera system in the assembled state;

FIG. 3 in partial Figures a, b and c shows details in connection with a lens as a passive accessory component, wherein in FIG. 3a a scale ring, in FIG. 3b a view of the operating unit, and in FIG. 3c this operating unit is schematically illustrated after a calibration procedure;

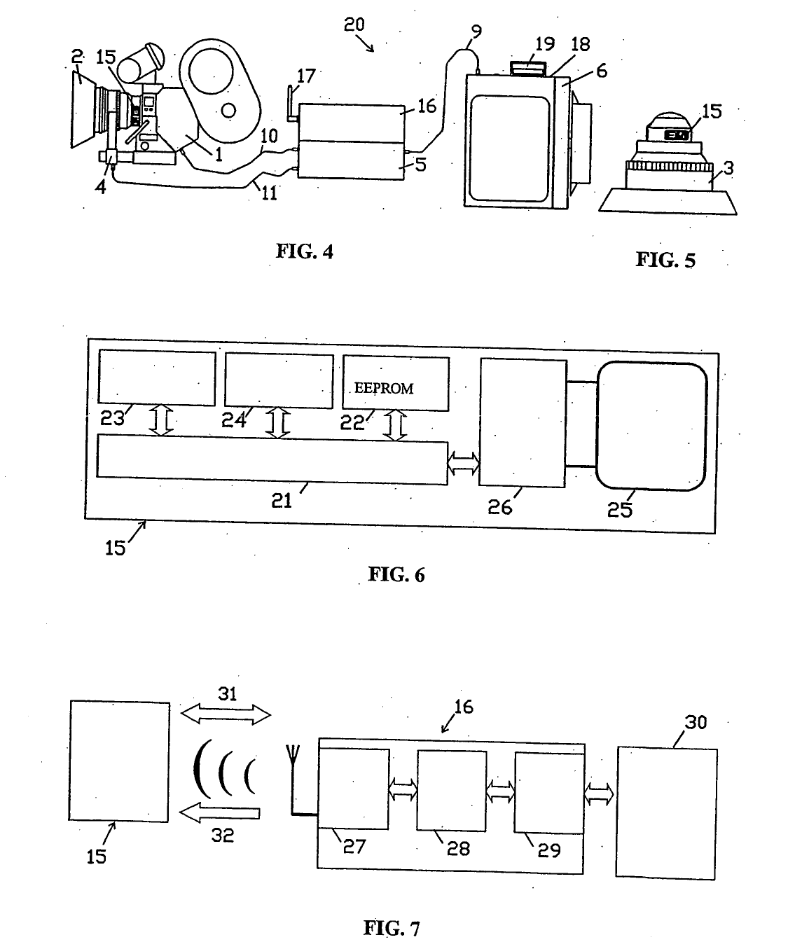

FIG. 4 shows a camera system comprising the technique according to the invention,

FIG. 5 shows a view of a passive accessory component in the form of a lens with a transponder attached thereto;

FIG. 6 schematically shows the electronic structure of a transponder;

FIG. 7 schematically shows the cooperation of an electronical acquisition device comprising such a transponder or the associated application system, respectively;

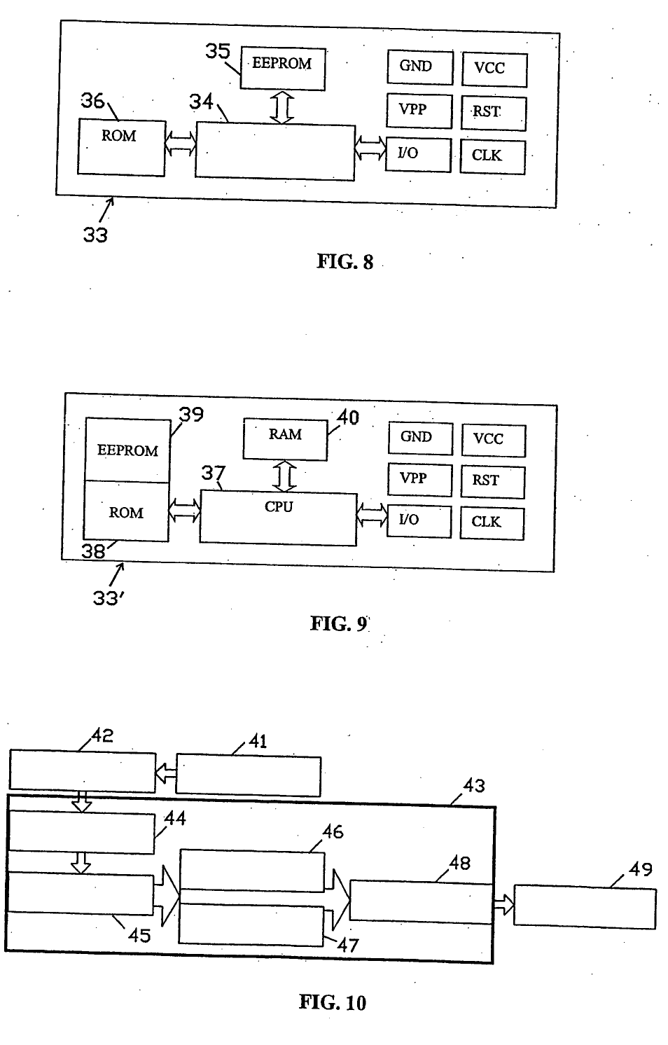

FIG. 8 schematically shows the structure of a simple mobile memory card;

FIG. 9 shows the structure of a modified memory card equipped with a processor;

FIG. 10 shows a flow chart of the procedure when starting up the operation of a camera system comprising a passive accessory component (here formed by a lens);

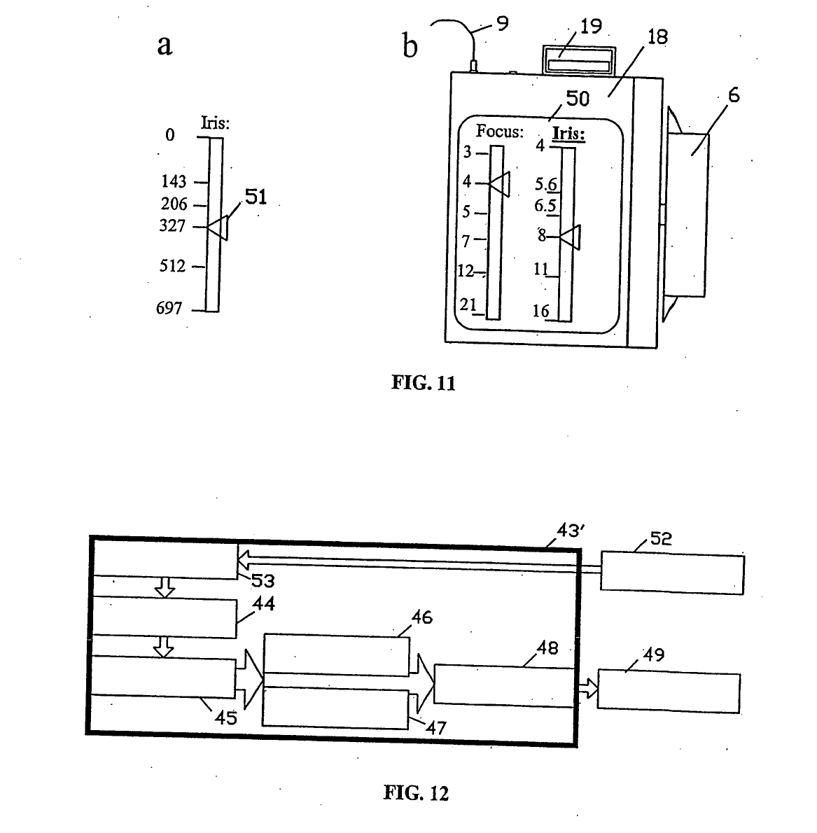

FIG. 11, in partial Figures a and b, schematically shows a possible indication (display) of the information obtained herein (FIG. 11b) as compard to the actual positions of the servomotor (FIG. 11a);

FIG. 12 in a flow chart similar to FIG. 10 shows the procedure when changing the lens;

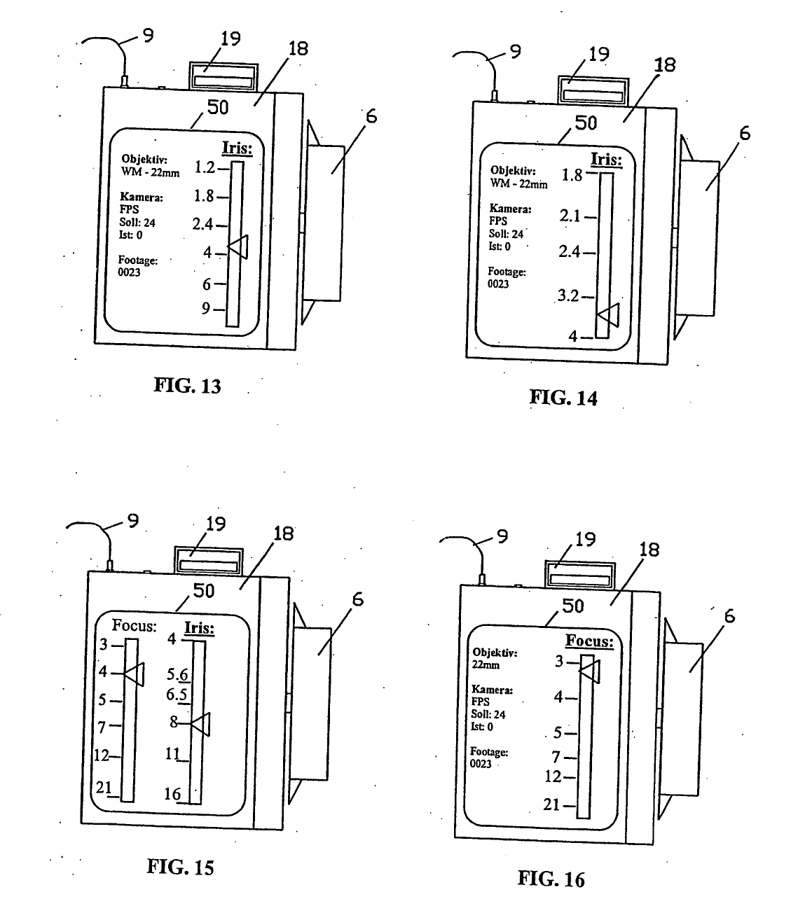

FIG. 13, in a schematic view corresponding to FIG. 11b, shows an illustration of the display for the lens now being used;

FIG. 14 shows a comparable display illustration, yet here with an extended lens scale (chart); and

FIGS. 15 and 16 show two examples of user-specific display configurations in illustrations corresponding to FIGS. 11, 13 and 14, respectively.

FIG. 1 shows a simple example of a camera system in which the individual components are illustrated separately from each other. In detail, a camera 1, a first lens 2, a second lens 3, a servo-drive 4 for an axis, actually for adjustment of one of the lenses 2, 3, a control unit 5 for the servo-drive 4, as well as an operating unit 6 therefor are shown. In FIG. 2, this camera system is illustrated in the assembled state, with the first lens 2 having been mounted on the camera.

By way of this example of a per se conventional camera system, as illustrated in FIGS. 1 to 3, and the mode of operation with the lenses 2, 3, the basic problem of the invention shall be explained by way of an introduction.

For various movie-shooting conditions, different lenses, e.g. 2, 3 are used, wherein the lenses 2, 3 may also come from different producers. In order to achieve functions of automation, checking and remote control, the lens is adjusted, e.g. by rotating a scale ring 7, cf. FIG. 3a, by means of an external drive, i.e. the servo drive 4 in this instance. This servo drive 4 is flanged to the scale ring 7 of the respective lens 2, or 3, respectively, and via a toothed pinion 8 of the servo drive 4, its rotary movements are transmitted to the scale ring 7 of the respective lens, e.g. 2, more or less without any clearance.

To simplify matters, in the present example only one servo drive 4 is explained for shifting “an axis”, yet of course, also several axes can be operated in parallel, e.g. by using servomotors for adjusting the distance (focus), for adjusting the lens aperture (iris) and for adjusting the focal distance (zoom), yet also other controls or axes are possible.

Then, according to FIG. 2, the operating unit 6 is connected to the control unit 5 so as to transmit adjustments carried out on the operating unit 6 to the control unit 5. In this instance, the operating unit 6 is the user interface for controlling the servo drive 4. In this manner, the user can pre-determine set values for the servo drive or servomotor 4, in the simplest case via a rotary potentiometer of the operating unit 6. Likewise, it is known to carry out direct camera operations, such as, e.g., start of shooting, stop of shooting etc., at such operating units of servomotors, with a key switch not further illustrated in FIG. 2 possibly being provided on the operating unit 6 for this purpose.

On the one hand, the control unit 5 is connected to the camera 1 so as to supply the motors thereof with power and to transmit camera commands inputted at the operating unit 6 to the camera 1.

On the other hand, the control unit 5 is connected to the servomotor 4 so as to supply the latter with power and to allow for a bidirectional data transmission between the latter and the control unit 5.

Instead of the cable connections 9, 10, 11 illustrated in FIG. 2 for this purpose, upon demand of course also a radio communication may be provided, with the transmission frequencies mainly being in the range of 2.4 GHz or 868 MHz. This does not make any difference functionally for the present invention, and to simplify matters, the provision of cable connections will be further assumed in the following.

When starting such a per se conventional camera system, e.g. according to FIG. 2, a calibration procedure of the servomotor 4 (or of all servomotors, if, as usual, several such motors are provided) occurs after switching on the camera 1. This calibration procedure will be explained in more detail by way of FIG. 3. After the calibration, specific data may be marked on the operating unit 6 for the respective accessory, e.g. the lens 2, whereafter it is possible to work with the camera system.

Calibration of the servomotor 4 (or of the servomotors) is necessary since during the assembly, this servomotor 4, when it is flanged to the respective scale ring 7 of the lens 2 or 3, respectively, (or to other operated parts of accessory components), does not know the position of the lens graduation, and generally, the adjusted positions of the passive accessory components, or this position is not known to its control unit, respectively. In the example illustrated, i.e. in the case of lens 2, the servomotor 4 will automatically move to the two end stops of the scale ring 7 during the calibrating procedure, and the positions of the two end stops will be stored in the control unit 5 of the servomotor 4.

Here it should be noted that in FIG. 3 only one scale ring 7 has been shown for the lens aperture of lens 2 for the sake of simplicity, calibration by way of this example of an iris scale being explained. In professional lenses, an iris scale as provided by the scale ring 7 according to FIG. 3a is lens-specific, i.e. these scales are different for different lenses. During their production, the lenses, e.g. 2, are measured, and the respective scale values are engraved on the scale ring 7. On the other hand, the motor movement usually is sensed in the servomotor 4 by sensors (not illustrated) and transmitted to the control unit 5 as position count value. During the calibrating procedure, the servomotor 4 now slowly moves towards an end stop—assumable towards lens aperture value “4”. As soon as the servomotor 4 has reached the end stop, the control unit will know the left-hand stop. Now the servomotor 4 moves towards the right-hand stop, the motor sensors transmitting to the control unit 5 the number of incremental steps from the left-hand stop to the right-hand stop (value of the position counter). For instance, when calibrating the iris scale of lens 2, the following values will result:
Left-hand stop (corresponding to scale value “4”) . . . position counter: 0
Right-hand stop (corresponding to scale value “1”) . . . position counter: 697

Starting from the calibrating procedure, the control unit 5 will know the exact relative position of the scale ring 7 relative to the end stops. If the scale ring 7 is located at “5.6” as in FIG. 3a, the control unit 5 will know the associated position count value (e.g., “143”). Yet, the system has no information about the engraved value “5.6”.

A mechanic abutment on the lens end stops can be avoided by stopping the motor 4 at the position count values 1, and 696, respectively.

Since when using servomotors, the lens, e.g. 2, in most cases will be out of the field of vision of the user while he is using the lens, the user will require information on the absolute position of the lens. For this purpose, the engraved values of the lens 2 are previously sketched on the operating unit 6. The operating unit 6 includes two mechanic stops 12, 13 which usually are spaced apart by approximately 270°. Normally, there is a region around the adjustment button of the operating unit 6 in which information can be entered by hand writing. This region 14 has been marked in FIG. 3b and does not change its position when the adjustment button is moved. If the adjustment button of the operating unit 6 is rotated from the left-hand stop 12 to the right-hand stop 13, the iris scale will move from value “4” to value “16”. These values are entered in hand writing in the region 14 provided therefor, cf. FIG. 3c. By optically checking the lens graduation, the user must now move to the other engraved values with the help of the operating unit 6 and enter them in the region 14 provided therefor on the operating unit 6. In FIG. 3c, the operating unit 6 is illustrated after this procedure.

After this step, the camera system is fully operative.

Now, if there is an exchange of lenses, e.g. from lens 2 to lens 3, the present lens scale (e.g. iris scale) will have different engraved values and end stops than with the first lens 2. Therefore, the user must repeat the entire procedure of preliminary adjustments for the servomotors so as to have a ready-to-use camera system. If lens 2 is used subsequently to lens 3, all the preliminary adjustments must once more be made so that the system can be used. This is where the invention sets in which avoids the loss of data already recorded, such as the previous calibrating data, during an exchange and a change back of the lenses or, generally, of passive accessory components.

An appropriate example of a camera system according to the invention is shown in FIG. 4, wherein the components also present in the system according to FIG. 2 have the same reference numbers and will not be explained again. In addition, it is provided for a contactless memory medium 15, preferably in the form of a transponder 15 (to simplify matters, reference will only be made to the transponder 15 hereinafter) to be mounted on the respective passive accessory component, i.e. here, e.g., on lenses 2 and 3, for instance directly (or on the wrapping thereof), cf. also FIG. 5, where a direct attachment on the lens body is illustrated. Moreover, the control unit 5 has an associated electronic acquisition device 16, which preferably is a writing and reading device and which communicates with the transponder 15 in wireless form—cf. antenna 17. Furthermore, the control unit 5, or the operating unit 6, respectively, has an associated display unit 18, and moreover, a memory unit 19 is provided so as to store special data in a non-volatile memory medium, i.e. a memory card, in particular, as will be explained in more detail hereinafter. In combination, the components 5, 6, 16, 18 and 19 thus all together form a “control device” 20, whereas in the known camera system according to FIG. 2, the corresponding control device 20 is merely formed by the components 5 and 6.

The contactless memory medium, i.e. the transponder 15, is lastingly mounted on the respective passive accessory component, here on lens 2, or 3, respectively, so that it will be possible to store respective data thereon and to read them therefrom, which is done without any contact. The acquisition device 16, i.e. a writing and reading device in the preferred embodiment, writes the data obtained via the control unit 5 and operating unit 6 into the transponder 15, and subsequently it can read these data from the transponder 15 again. This writing and reading unit 16 is actively connected to the control unit 5 of the camera system. The display device 18 serves for an overall display of information stored in the non-volatile memory medium as well as of further actual dynamic information of the camera system. With this, an association of the user-specific dynamic data (e.g. the above-described position count values) to the stored data is possible.

The field of application of this technique comprises all passive accessory components which are used in a camera system. In the following, the mode of function of the automatic adaptation of the control and display system of a camera 1 as a function of the configuration of the camera system again will be described in an exemplary manner by way of lenses 2, 3. The units 5, 15, 16, 18, 19 and 6 are each illustrated separately in FIG. 4. However, they may also be integrated to a unit accommodated in a housing or in the camera housing, respectively. Particularly when using different passive accessory components it makes sense to connect the read and write unit 16 for the transponder 15 to the camera housing and to directly connect it electrically to the control unit of the camera 1. For a better overview and since in this actual example always only one transponder 15 is used for lenses 2, 3, in FIG. 4 the read and write unit 16 is shown directly connected to the control unit 5 of the motors 4. Since in a modern camera system, all the active accessory components are capable of inter-exchanging data, functionally there is no difference where the read and write unit 16 for the transponder 15 is connected. Independently of the electric connection of the read and write unit 16, this unit 16 must, of course, be mounted within a radio range to the possible transponder positions (e.g. also on the wrapping).

The contactless memory medium (transponder 15) is per se conventional and based, e.g., on the RFID (radio frequency identification) system, which is composed of two parts, i.e. the transponder attached to the respective object (also called “tag” or chip card) (here, for the sake of simplicity, in the following the term “transponder” is used throughout without being restrictive), and the RFID acquisition device (write-read device) for the transponder 15, subsequently called acquisition device 16 without being restrictive. In the simplest case, the transponder 15 forming the data memory consists of a microchip and an antenna. In FIG. 6, the basic set-up of such a conventional transponder 15 is illustrated, a digital control unit 21 being present as the central element, which control unit cooperates with an EEPROM memory 22. Furthermore, there are an associated anti-collision logic 23 and an access control 24 so as not only to check the memory access itself, but also the access to the transponders 15 within a response range in which there are several transponders. By this it is possible to selectively activate individual transponders 15 within the responsive range.

As the interface between the digital control unit 21 and an antenna 25, an analogue unit 26 is provided which also contains a capacitor not further illustrated for storing electric energy.

The antenna 25 may be realized as a conductor loop or wire loop. Also dipole antennas are used. If the antenna is formed as a loop, it will extend around the microchip (components 21 to 24 and 26) in most cases.

Due to the EEPROM-memory 22, the transponder 15 not only is a ROM, but it can also be written in from the outside. At present, transponders having a memory depth of 10 KBit are on the market. In more recent systems, the memory 22 can be segmented, i.e. certain memory blocks can be made accessible to various users. Each memory range can be irreversibly secured against new overwriting. EEPROM memories usually can be written on for a few 100,000 times. Memory 22 may also contain an identification number (with consecutive serial number, producer code) and be requested.

Transponder 15 has no contacts to the outside. As a rule, it has no voltage supply of its own and is completely passive outside a certain distance from the acquisition device 16—the responsive range. Within the responsive range, the transponder 15 is activated. The energy required to operate the transponder 15 is transmitted contactless, just like the data, by means of electromagnetic waves.

Transponders 15 are comparatively insensitive relative to external influences, such as dirt or humidity. For communicating with the acquisition device 16, they require neither an optic intervisibility nor a special orientation. Depending on the producer, transponders have dimensions in the millimeter or centimeter range. The thickness of the microchip is less than 1 mm.

The acquisition device 16 which may be both a read and a write device, typically comprises a radiofrequency module 27 with an antenna, a digital control unit 28 and an interface 29 to continuing automation devices 30—cf. FIG. 7.

The connection between the acquisition device 16 and the transponder 15 is contactless by means of electromagnetic waves. Depending on the producer and technology, RFID systems operate in various frequency bands. Common frequencies are the ranges around 134 kHz, 13.56 MHz (ISO standard 15693 or 14443) or other nationally approved ISM frequencies (ISM—Industrial/Scientifical/Medical). The data rate at data transmission (cf. double arrow 31) varies according to producer and standard. In standard ISO 15693 data rates of 26.48 KBit/s are possible; ISO 14443 allows for data rates of 106 KBit/s. Data transmission is ensured by CRC (cyclic redundancy check). Amplitude modulation (ASK) or phase modulation (PSK) are employed as modulation methods.

In the communication of the acquisition device 16 with the transponder 15, it is distinguished between two modes of operation, i.e. the read mode and the write or programming mode. Both states of operation are started with the charging cycle of the capacitor provided on the transponder 15, via the voltage induced by means of electromagnetic waves. This energy transmission is indicated by arrow 32 in FIG. 7. Transponder 15 detects the end of the charging cycle and transmits its data in the read mode of operation. This is accomplished by interfering with the output signal of the acquisition device 16. Thus, transponder 15 itself does not transmit, but with its basic load it acts as a load on the emitted field. This additional energy removal is noticeable by an amplitude modulation of the starting signal retroactive via the field and can be evaluated by the acquisition device 16 after an appropriate amplification and demodulation.

After charging, the transponder 15 can also be brought into the programming mode. The data transmitted by the acquisition device 16 are stored in transponder 15 in EEPROM memory 22. Usually, the data stored by transponder 15 are returned to the acquisition device 16 for checking purposes.

Depending on the frequencies, antennas and field strengths used, the responsive ranges can be realized from a few centimeters to as far as one meter and therebeyond. Thus, systems according to ISO 15693 in the 13.56 MHz range with an antenna on the reading/writing device 10 of a diameter of 65 cm, a transmission output of 4 W and a credit-card sized transponder 15 achieve a range of 1 m.

The interface between the acquisition device 16 and the application system 30 corresponds to an international standard, e.g. RS 232 or RS 485. In the application, the memory data can be visualized or pre-determined, cf. the operating unit 6 and the display device 18 above. The control unit 28 in the acquisition device 16 usually is a digital signal processor which provides the connection between the analogue unit 27 and the external application system 30 and checks the connection establishing to the transponder 15.

In the following, memory cards in the form of chip cards or the like shall be explained by way of FIGS. 8 and 9 as examples of mobile memory media.

The term chip card designates an electronic data memory, optionally with an additional computer performance (microprocessor card) which in most cases is installed in a plastics cover in the manner of a credit card. In the last few years, also other memory media with an electronic function similar to that of a chip card have appeared on the market. Such memory media are obtainable in PCMCIA, compact-flash, mini-PCI-card format or similar standardized or company-specific housing formats, such as memory-stick.

The chip card or like memory media are supplied from the acquisition device 16 with electric energy and a clock via a galvanic connection. Data communication also occurs via the contacts.

With the chip card, the contacts are formed as contacting areas on the upper side of the plastics card, cf. also the right-hand part of the illustrations in FIGS. 8 and 9. The acquisition device 16 is connected to the card via contact springs. With a chip card, data transmission between the acquisition device 16 and the card itself occurs via a bidirectional serial interface (I/O port). One of the most important advantages of the chip card consists in that the data stored therein can be protected against undesired reading accesses and manipulations. In other, similar memory media, a parallel data communication with the acquisition device dominates. In most cases, these memory media are not protected against an undesired reading access, but, on the contrary, an easy data manipulation from the most varying acquisition devices shall be enabled.

With the chip card or similar mobile memory media, it is distinguished between two basic types of cards, i.e.
mere memory cards which mainly serve to store data, and
microprocessor cards in which a program application is possible in addition to data storage.

These two types shall be described in connection with the example of the chip card.

In the chip card 33 according to FIG. 8, access is made to a memory 35—in most instances in the form of an EEPROM—via a sequential logic 34 (state-machine). With this, also simple safety algorithms can be realized. The (address- and safety-)logic 34 has an associated reading memory 36; furthermore, the usual contacts such as clock (CLK), ground (GND), voltage supply (VCC), I/O port (I/O) etc. are indicated in FIG. 8 (and, accordingly, in FIG. 9), more detailed explanations not being required for this.

In contrast to mere memory cards, microprocessor cards, such as card 33′ of FIG. 9, contain a microprocesor 37 which is connected to a segmented memory (ROM-, RAM- and EEPROM-segment). In FIG. 9, the schematic structure is visible. The mask-programmed ROM 38 contains a higher-ranking program code (an operating system) for the microprocessor 37 and is applied during manufacture of the chip. The content of the ROM memory 38 can no longer be overwritten. In EEPROM 39 of the chip, there are the application data and the application-specific program code. However, this memory code can only be read or written under the control of the operating system. The RAM 40 is the temporary working memory of microprocessor 37. The data stored in RAM 40 are lost when the supply voltage is turned off. The application-specific program parts or data can be handled with the utmost flexibility.

Such a mere-memory card 33 or processor memory card 33′ (or a similar mobile memory medium) cooperates with the memory unit 19, with a card insert, on the display device 18 for the storing and reading out of data, respectively. To simplify matter, this memory medium 33, 33′, will be called memory card hereinafter, which is meant to include all the most varying embodiments indicated above. Therefore, this designates a mobile memory medium which can be personally associated to the respective user so as to keep stored data specifically related to this user.

When using a camera system, such as according to FIG. 4, according to the flow chart of FIG. 10 initially, according to step 41, such a personal memory card 33, 33′ is inserted in the insertion slot (memory unit 19), and subsequently, in step 42, the camera 1 is switched on. There follow several automated procedures, as indicated in FIG. 10 by block 43 enclosed by the bold-line box. In detail, initially a calibrating procedure, block 44, for the servomotor.4 (or the servomotors) is carried out, whereupon in step 45 the identification numbers of the transponders 15 within reach are read. After identification of the correct transponder 15, according to step 46 lens data are transferred from the transponder 15 into the control unit, and according to step 47 associated data are transferred from the memory card 33, or 33′, respectively, into the display device 18. This data transfer at 46, 47 occurs, e.g., in parallel, and subsequently the display is updated in step 48. After these automated procedures, working with the camera system can be started, as indicated at block 49 in FIG. 10.

The illustrated flow can be modified by different user requests. In the instant example, it is assumed that the data from the following Table 1 in transponder 15 are provided by a previous use or by an external service.

TABLE 1

| | Lens 2 | Lens 3 |
|---|---|---|
| Identification | OOOOOO1 | OOOOOO2 |
| number: | | |
| Producer: | CT | WM |
| Type: | zoom lens (28/68) | fixed focal |
| | | length (22) |
| Graduations: | F I Z | F I |
| Focus graduation: | L(0); 3(25); 4(51); | L(0); 1.8(0); |
| | 5(98); 7(312); | 2.2(120); 3.1(274); |
| | 12(521); 21(634); | 4(362); 5.6(489); |
| | R(793) | 8(601); 11(734); |
| | | R(743) |
| Iris graduation | L(0); 4(0); 5.6(143); | L(0); 1.2(40); |
| | 8(327); 11(512); | 1.8(88); 2.4(150); |
| | 16(697); R(697) | 4(376); 6(512); |
| | | 9(685); R(777) |
| Zoom graduation | L(0); R(822) | |

The personal memory card 33 or 33′, respectively, should always stay with the user, even if the camera system is returned to the rental, and when starting the use (step 42), it is inserted into the insertion slot provided therefor in the memory unit 19. Beside product-specific information, different configurations of the user interface are stored here. In Table 2, the contents of two different memory cards (for different users X, Y) are indicated for the present example.

TABLE 2

| | |
|---|---|
| User X | User Y |

| | | | |
|---|---|---|---|
| Identification | OOOOOO1 | OOOOOO2 | OOOOOO1 |
| number: | | | |
| Information: | optically | — | — |
| | insufficient | | |
| | at focal | | |
| | length 28 - | | |
| | rim region out | | |
| | of focus | | |
| Display: | iris | iris | focus |
| | graduation, | graduation | graduation |
| | focus | | |
| | graduation | | |
| Show lens | no | yes | yes (focal |
| information | | (producer, | length) |
| | | focal length) | |
| Show camera | no | yes (FPS, | yes (FPS, |
| information | | Footage) | Footage) |
| Focus | — | — | |
| graduation: | | | |
| Iris | 6.5(206) | — | |
| graduation: | | | |
| Hand unit for | Standard | Standard | Standard |
| manual | adjustment: | adjustment: | adjustment: |
| operation | Iris | Iris | Focus |

After having switched on the camera (step 42 in FIG. 10), there follows the calibrating procedure 44; in the present system, an absolute position of the scale rings (7 in FIG. 3) of the control device is not provided. Since the lens graduations in the turned-off state can be rotated, also in this system the instantaneous position of motor 4 must be determined by means of the calibrating procedure. After the calibrating procedure, the following values result for the iris scale of lens 2 as in the example according to FIG. 3:
left-hand stop position counter: 0
right-hand stop position counter: 697

Reading of the identification number (step 45 in FIG. 10) may also be effected prior to the calibrating procedure 44; in a known manner, the identification numbers of all the transponders within reach are read out here. In this example, the transponder 15 mounted on lens 2 is read out here. Starting from this point of time, the information on the currently used accessories are known to the display and control devices, and the transfer of the lens data from the transponder 15 and of the associated data from the mobile memory card 33, 33′ can take place (this procedure 46, 47 can also be carried out prior to the calibrating procedure 44—then, theoretically, only finding of the end stop would be necessary). After the reading of the identification number, step 45 in FIG. 10, the data associated to this identification number are read by the display and control devices from the memory media available. In the present example, the following data are available to user X:
Product-specific data from transponder 15:
informative contents directly indicated on the display (producer, type, etc.)
association of position count values of the motors with graduation (scale) values; in Table 1 this is illustrated as follows (Iris scale lens 2):
   L(0) . . . left-hand stop at position counter value 0;
   4(0) . . . lens aperture value 4 at position counter value 0;
   5.6(143) . . . lens aperture 5.6 at position counter value 143; (analogously, the other values and graduations are illustrated).
User-specific data from memory card 33, or 33′, respectively:

Here the information belonging to this product—identified by the already read identification number—are read out. This may, e.g, comprise:
stored informative contents regarding the product; in Table 2, e.g., regarding identification number of lens 2 (0000001), the information “optic problems at focal length 28”0 are stored;
further graduation values regarding the product which are of interest to the user, which he has stored in previous application; in Table 2, e.g., a further graduation value—6.5 is stored;
display information regarding this product; in Table 2, e.g., it has been stored that the one user X in product lens 2 desires the display of the iris and focus graduations—therefore, the zoom graduation is not shown;
occupying hand-operated units; in Table 2, e.g., it is stored that with this product, the user as a standard wishes to adjust the iris graduation with the hand unit for manual operation.

After the reading of all the stored information, according to step 48 in FIG. 10 the display can be adjusted to the desired state.

FIG. 11a shows the internal set-up of the iris display. The illustrated range of the iris graduation used here is subdivided into 697 parts. On this graduation forming, marks are shown at the position count values (0, 143, 206, 327, 512, 697). As values beside the marks, the corresponding values (4, 5.6, 8, 11, 16) are displayed from the memory media. Due to this display, the user has an image of the lens graduation usable for him. FIG. 11b shows the screen 50 visible for user X.

During the operation, the actual position counting value (adjusted value; e.g. “327”) is always provided dynamically by servomotor 4. This actual value is indicated by an arrow 51 in this example (cf. FIG. 11a). In the case of the iris graduation viewed, this actual value at present is indicated by arrow 51 at value 327. By the technique presented here, an association of this dynamic application-specific value (“327”) to the display value (“8”) relevant to the user is possible. Thus, the instantaneous iris value (“8”) is visible for the user, cf. FIG. 11b.

Since all the steps following a switching on of the camera occur automated, the user has an operative camera system shortly after having switched on the system. Of course, user requests can be integrated into the process so as to give the user a greater flexibility; e.g., it could be requested if
the graduation values stored in transponder 15,
or individual graduation values regarding lens 2, or 3, respectively, provided on the memory card 33, or 33′, respectively,
or both graduations should be displayed in different colors.

Yet also the type of starting procedure—whether or not such or similar requests should occur—may be pre-determined individually on the personal memory card 33, or 33′, respectively.

After this example, various configurations and the resultant display variants shall be explained. For instance, it will be assumed that user X changes from lens 2 to lens 3. The corresponding steps are shown in FIG. 12.

If the lens is exchanged (step 52 in FIG. 12), normally transponder 15 of lens 2 is without and transponder 15 of lens 3 is within the functional reach of the read and write device 16. If several transponders 15 of the same type (e.g. when storing the non-used lenses next to the camera) are within the reach of the read and write device 16 for an extended period of time, it must be clarified by a user request which lens shall be used for the further display.

After recognition of the new transponder (step 53), the steps 44-48 of FIG. 10 are carried out analogously, cf. FIG. 12; a new description thereof is not required. In the personal memory card 33, or 33′, respectively, of user X (cf. Table 2), for lens 3 the display
of the iris graduation,
of lens data (in this case producer and focal length are indicated by way of example), and
of camera data (in this case the actual and set operating speeds of the camera FPS—and the current value of the film count mechanism footage—are indicated) was fixed.

With these and the data read from the transponder 15 of lens 3 (cf. Table 1), the display 50 illustrated in FIG. 13 will result without any further activity on the part of the user.

If, for instance, the user works mainly in the iris range with lens aperture values of between 1.8 and 4, the user now has the possibilities (via a user interface to be defined)
to illustrate this region of interest for him in display 50 on an enlarged scale
to take up new numerical values in this region into the display 50, and optionally
to store these new numerical values
on the transponder 15 in product-specific manner and/or
on his personal memory card 33, 33′.

If in this case the user takes up two new values 2.1(61) and 3.2(240), he stores them in transponder 15, and he fixes the display of the expanded scale in his personal memory card 33; this will result in the display 50 shown in FIG. 14. The relevant changed data on the memory media are illustrated in the following Table 3.

TABLE 3
Transponder 15

| | Lens B |
|---|---|
| Identification number | OOOOOO2 |
| Iris scale | L(0); 1.2(40); 1.8(88); 2.1(61); |
| | 2.4(150); 3.2(240); 4(376); |
| | 6(512); 9(685); R(777) |

Personal memory card 33

User X

| | | |
|---|---|---|
| Identification | OOOOOO1 | OOOOOO2 |
| number | | |
| Display: | iris graduation, | expanded iris |
| | focus graduation | scale (1.8-4) |

In the expanded lens scale of FIG. 14, only the position count values from 88 to 376 are displayed. In parallel, also the permitted adjustment range of the adjustment button of the operating unit 6 (here for the iris) can also be restricted to this range 1.8-4. If this region is expanded to the mechanically possible adjustment range (270°), the positioning precision of this operating unit 6 can be enhanced.

Assuming another user Y uses the same equipment from the same rental as the first user X, they will attend to different productions, and the applications will be different. By the technique presented here, the equipment will be configured according to his needs beginning from the startup. Since user Y uses his personal memory card 33, or 33′, respectively (configuration cf. Table 2), following startup of the system, a completely different display will result which will be adapted to the needs of user Y. In FIGS. 15 and 16, both displays are shown by way of comparison. For the sake of completeness, it should be mentioned that according to FIG. 15, in operating unit 6 the adjustment button serves to adjust the iris “axis”, and in FIG. 16 for adjustment the focus “axis”.

The numerical values stored in association with the position count values can be chosen arbitrarily. What the user wants to see is always decisive. Thus, e.g., a user could employ a meter lens, yet wish to display “feet” values on his display. Since he can store any desired corresponding values associated to the position count values, this is feasible with this technique without any problems. Likewise, any desired mathematic links can be indicated on display 50. For instance, if the required data are stored in the memory media 15 and/or 33, or 33′, respectively, calculations regarding the actual depth of focus can be effected and the values can be displayed on display 50.

Besides the use of this identification and memory system for lenses elaborately described in this example, there exist numerous other possible applications with other passive accessory components. By way of example there may further be mentioned
transponders on batteries:

Stored information: battery type, capacity, threshold voltage.

With different batteries, the voltage values are different at which sufficient energy can no longer be provided. Thus, e.g., rechargeable lithium ion batteries will have different values than rechargeable nickel cadmium batteries. Depending on the threshold voltage, the display for “low bat” (insufficient battery voltage) may simply be adapted with the new technique.
Transponders on optic filter systems:

Stored information: type of filter system.

On display units of the camera system, the instantaneously used type of filter system can be displayed and further processed in a data acquisition device.
Transponder on mechanic film magazines:

Stored information: type of magazine, maximum allowed speed.

The maximum allowed operating speed of the camera system may be adapted as a function of the magazine mounted and be displayed.

By the technique described it has thus become possible to provide data on arbitrary passive accessory components to the control and visualizing system of a camera. It is also made possible to safeguard information acquired during use also on passive accessory components themselves as well as in a memory associated to the user. Moreover, also the data of previous applications can be displayed as a function of the accessories used and/or as a function of the user.

1-27. (canceled)

28. A system, comprising:
a camera;
at least one passive camera-accessory component associated with said camera;
a contactless memory medium mounted on said passive accessory component and that said control device has an electronic acquisition device for communicating with said contactless memory medium; and
a control device connected to said passive camera-accessory component, said control device having an electronic acquisition device for communicating with said contactless memory medium.

29. The system according to claim 28, wherein said contactless memory medium is a transponder.

30. The system according to claim 28, wherein said acquisition device is a read/write device.

31. The system according to claim 28, wherein said contactless memory medium is configured to store data related to said passive accessory component and/or an operation thereof.

32. The system according to claim 28, wherein said control device has an associated memory unit with a mobile memory medium for storing data related to said passive accessory component and/or an operation thereof.

33. The system according to claim 32, wherein said mobile memory medium is a memory card.

34. The system according to claim 32, wherein said mobile memory medium furthermore is adapted for storing personal accessory-specific data.

35. The system according to claim 32, wherein said control device further includes a display device and said mobile memory medium is adapted for storing information regarding said display device or a configuration thereof.

36. The system according to claim 35, wherein said memory medium is adapted to store the information as a function of the passive accessory component.

37. The system according to claim 28, wherein said camera is a movie camera.

38. The system according to claim 28, wherein said camera is a video camera.

39. The system according to claim 28, wherein said camera is a photo camera.

40. The system according to claim 28, wherein said passive accessory component is an exchangeable lens.

41. In combination with a camera, a passive accessory component for the camera, comprising a contactless memory medium mounted to said passive accessory component.

42. The passive accessory component according to claim 41, wherein said contactless memory medium is a transponder.

43. The passive accessory component according to claim 41, wherein said contactless memory medium is configured to store data regarding the passive accessory component and/or an operation thereof.

44. The passive accessory component according to claim 43, wherein a drive motor is associated with the passive accessory component, and said contactless memory medium is configured to store counting values of said drive motor in combination with associated graduation values or engraved values of the passive accessory component.

45. The passive accessory component according to claim 41 configured as an exchangeable lens for the camera.

46. In a camera having at least one passive accessory component associated therewith, a control device comprising an electronic acquisition device connected to communicate with a contactless memory medium on the passive accessory component.

47. The control device according to claim 46, wherein said electronic acquisition device is a read/write device.

48. The control device according to claim 46, which further comprises a memory unit with at least one mobile memory medium for storing data specific to the passive accessory component and/or an operation thereof.

49. The control device according to claim 48, wherein said memory unit is configured to store personal, accessory-specific data on said mobile memory medium.

50. The control device according to claim 49, which further comprises a display device, and said memory unit with said mobile memory medium is adapted to store information regarding said display unit, or a configuration thereof.

51. The control device according to claim 50, wherein said memory medium is adapted to store the information as a function of the passive accessory component.

52. The control device according to claim 50, wherein said display device is adapted to display actual positions of a power-assist drive associated to the passive accessory component.

53. The control device according to claim 48, wherein said mobile memory medium is a personal memory card.

54. A control device for a passive accessory component associated with a camera, comprising: a memory unit having at least one mobile memory medium for storing data related to the passive accessory component.

55. The control device according to claim 54, wherein said memory unit is configured to store personal, accessory component-specific data on said mobile memory medium.

56. The control device according to claim 54, which further comprises a display unit, and wherein said memory unit with said mobile memory medium is configured to store information regarding said display unit, or a configuration thereof.

57. The control device according to claim 56, wherein said memory medium is adapted to store the information as a function of the passive accessory component.

58. The control device according to claim 56, wherein said display unit is adapted to display actual positions of a power assist drive associated to the passive accessory component.

59. The control device according to claim 54, wherein said mobile memory medium is a personal memory card.
